(19) United States
(12) Patent Application Publication
(10) Pub. No.: US 2015/0232017 A1
(43) Pub. Date: Aug. 20, 2015

(54) AXIAL DIRECTION CONTROL DEVICE AND PROGRAM THEREOF

(71) Applicant: DENSO CORPORATION, Kariya-city (JP)

(72) Inventors: MASAYOSHI OOISHI, Anjo-shi (JP); HIROAKI NIINO, Toyota-shi (JP); YOSUKE HATTORI, Aichi-ken (JP); HIDESHI IZUHARA, Kasugai-shi (JP); HIROKI TOMABECHI, Aichi-ken (JP)

(21) Appl. No.: 14/622,975

(22) Filed: Feb. 16, 2015

(30) Foreign Application Priority Data
Feb. 17, 2014 (JP) 2014-027638

(51) Int. Cl. B60Q 1/08; B60R 1/00

(52) U.S. Cl. CPC B60Q 1/085; B60R 1/00; B60R 2300/101; B60Q 2300/324

(57) ABSTRACT

An axial direction control device obtains information regarding a road gradient in front of a road on which a motor vehicle drives. The axial direction control device adjusts an optical axis of headlamps and an image acquiring axis of an in-vehicle camera to an optimum direction on the basis of the acquired information before the motor vehicle has reached a road gradient change point. The road gradient is changed at the road gradient change point. Because the axial direction control device quickly changes the axial direction of each of the headlamps and the camera to an optimum direction before the road gradient is changed, driver safety and comfort is enhanced.

### CROSS-REFERENCE TO RELATED APPLICATION

This application is related to and claims priority from Japanese Patent Application No. 2014-27638 filed on Feb. 17, 2014, the contents of which are hereby incorporated by reference.

### BACKGROUND OF THE INVENTION

1. Field of the Invention

The present invention relates to axial direction control devices and programs of performing an axial direction control capable of adjusting a direction of devices, for example, an image acquiring axis of in-vehicle cameras and an optical axis of headlamps mounted on motor vehicles.

2. Description of the Related Art

There are axial direction control devices, for example, Japanese patent laid open publication No. JP 2008-247210 discloses a technique of adjusting an optical axis of headlamps of a motor vehicle on the basis of a tilt amount of the motor vehicle.

However, because the conventional axial direction control device previously described adjusts the optical axis of the headlamps only after the motor vehicle is tilted, a delay adjusting the optical axis of the headlamps is generated at a location when the motor vehicle is running on a road and a road gradient is changed, and it is accordingly difficult to quickly adjust the optical axis of the headlamps to an optimum axial direction in views of the surface of the road.

### SUMMARY

It is therefore desired to provide an axial direction control device, to be mounted on a motor vehicle, capable of adjusting an axial direction of devices having an axis such as an optical axis of headlamps and an image acquiring axis of an in-vehicle camera to an optimum direction even if the motor vehicle drives on a road and a road gradient is changed. The present invention also provides a program of performing the function of the axial direction control performed by the axial direction control device.

An exemplary embodiment provides an axial direction control device capable of controlling an axial direction of devices having an axis such as headlamps and an in-vehicle camera, mounted on a motor vehicle, into which a light is introduced or from which a light is irradiated. The axial direction control device has a change information acquiring section and an axial direction change section. The change information acquiring section is capable of acquiring road gradient change information. The road gradient change information indicates a road gradient change point, a change amount of a road gradient, etc. The road gradient indicates a gradient of the road in front of a motor vehicle. The road gradient is changed at the road gradient change point. The axial direction change section is capable of adjusting an axial direction of the devices to an optimum axial direction in views of the surface of the road on which the motor vehicle drives. The optimum axial direction adjusted by the axial direction change section correctly corresponds to the road gradient of the road after the road gradient change point, before the motor vehicle has reached the road gradient change point on the basis of the road gradient change information.

Because the axial direction control device having the structure previously described changes to the optimum axial direction of the devices having the axis such as the in-vehicle camera and the headlamps of the motor vehicle, before the road gradient is changed, it is possible to quickly adjust the axial direction of the device to the optimum axial direction corresponding to the slope of the road on which the motor vehicle drives even if the motor vehicle drives on the road in which its road gradient is changed.

It is preferable for the road gradient change information to have a change amount of the road gradient when the road gradient is changed upward and downward.

For example, there are following cases when the road gradient is changed to a positive direction, i.e. when the road surface of the road on which the motor vehicle drives is changed upward:

The motor vehicle drives on a downward slope and goes forward on a flat road;

The motor vehicle drives on an upward slope and goes forward on another upward slope having a large road gradient; and

The motor vehicle drives on a downward slope and goes forward on an upward slope.

Further, there are following cases when the road gradient is changed to a negative direction i.e. when the road surface of the road on which the motor vehicle drives is changed downward:

The motor vehicle drives on a downward slope and goes forward on another downward slope having a large downward slope;

The motor vehicle drives on an upward slope and goes forward on another upward slope having a small road gradient;

The motor vehicle drives on an upward slope and goes forward on a flat road; and

The motor vehicle drives forward on an downward slope.

It is possible to use a program in order to perform the function of the axial direction control device having the structure previously described. Here, the program is stored in a machine-readable storage medium such as a memory section and executable by a central processing unit.

### BRIEF DESCRIPTION OF THE DRAWINGS

A preferred, non-limiting embodiment of the present invention will be described by way of example with reference to the accompanying drawings, in which:

FIG. 1 is a block diagram showing a structure of an axial direction control device according to an exemplary embodiment of the present invention;

FIG. 2 is a flow chart of performing an axial direction adjusting process performed by a control section in the axial direction control device according to the exemplary embodiment;

FIG. 3A is a view explaining two cases in which a road gradient is changed upward as a positive (+) direction, and downward as a negative (−) direction;

FIG. 3B is a view showing start points, road gradient change start points at which a gradient of a road is changed, and completion points.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### EXEMPLARY EMBODIMENT

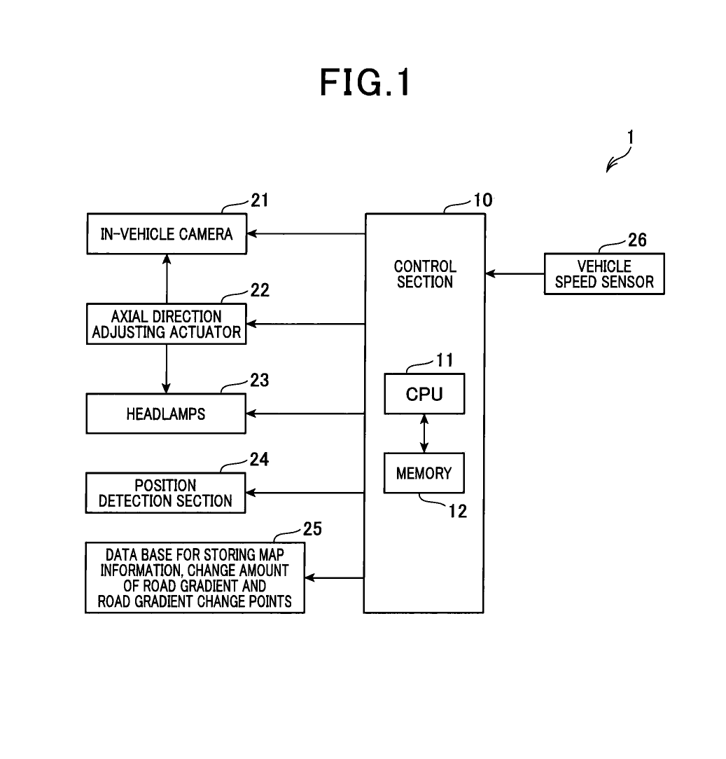

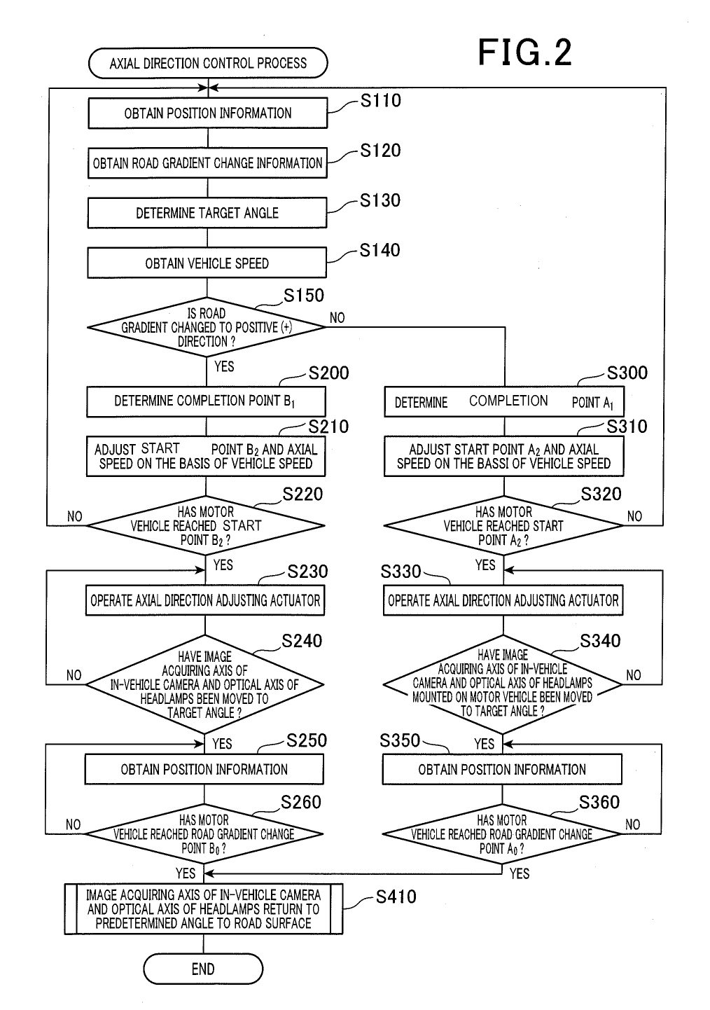

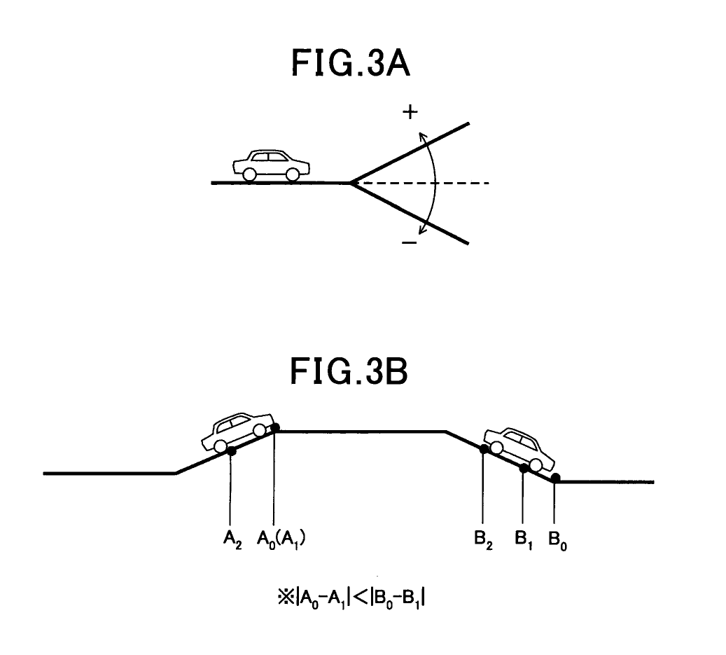

A description will be given of the axial direction control device 1 according to an exemplary embodiment with reference to FIG. 1, FIG. 2, FIG. 3A and FIG. 3B.

FIG. 1 is a block diagram showing a structure of the axial direction control device 1 according to the exemplary embodiment.

The axial direction control device 1 according to the exemplary embodiment is mounted on a motor vehicle, for example. As shown in FIG. 1, the axial direction control device 1 adjusts an axial direction of a device such as an image acquiring axis of an in-vehicle camera 21 and an optical axis of each of headlamps 23.

In particular, before a gradient (or a road gradient) of the road on which the motor vehicle drives is changed, the axial direction control device 1 according to the exemplary embodiment estimates a direction to which the motor vehicle would be tilted, and adjusts the axial direction of the devices such as the in-vehicle camera 21 and the headlamps 23 to an estimated direction as an optimum direction. This axial direction control makes it possible to adjust the axial direction of the devices to an optimum direction even if the road gradient varies.

As shown in FIG. 1, the axial direction control device 1 is equipped with a control section 10, the in-vehicle camera 21, an axial direction adjusting actuator 22, the headlamps 23, a position detection section 24, a data base 25 for storing map information, a change amount of a road gradient and a road gradient change point at which the road gradient is changed, and a vehicle speed sensor 26.

The in-vehicle camera 21 is capable of acquiring a front image of a road in front of the motor vehicle. The in-vehicle camera 21 transmits an acquired image to an image processing device (not shown). The image processing device performs a drive assist process capable of extracting a white lane and obstacles from the acquired image.

The headlamps 23 have a well-known structure in which a lighting state and a non-lighting state of the headlamps are switched on the basis of an instruction transmitted from the control section 10.

The axial direction adjusting actuator 22 adjusts an image acquiring axis of the in-vehicle camera 21 and an optical axis of the headlamp 23 on the basis of an instruction transmitted from the control section 10. For example, the image acquiring axis of the in-vehicle camera 21 is a central position of an image acquiring range of the in-vehicle camera 21, and the optical axis of the headlamp 23 is a central axis of a light irradiating area of the headlamp 23. In the exemplary embodiment, the image acquiring axis and the optical axis are shifted in a vertical direction.

The axial direction control device 1 according to the exemplary embodiment uses the axial direction adjusting actuator 22 capable of adjusting the image acquiring axis of the in-vehicle camera 21 and the optical axis of each of the headlamps 23. However, the subject matter of the present invention is not limited by this structure. For example, it is acceptable for the axial direction control device 1 to have a plurality of the axial direction adjusting actuators 22 mounted to the corresponding in-vehicle camera 21 and headlamps 23, respectively, in order to adjust each of the image acquiring axis of the in-vehicle camera 21 and the optical axis of each of the headlamps 23.

The position detection section 24 is a global positioning system (GPS) receiver, for example. The position detection section 24 is capable of detecting a current position of the motor vehicle on which the GPS is mounted. The position detection section 24 transmits information regarding the detected current position of the motor vehicle to the control section 10.

The data base 25 stores map information, a change amount of a road gradient, a change point at which the road gradient is changed, etc. In the exemplary embodiment, a change point of each of the road gradients, a change amount of the road gradient at each change point and corresponding information thereof are stored in the data base 25.

The vehicle speed sensor 26 detects a vehicle speed of a motor vehicle equipped with the axial direction control device 1 according to the exemplary embodiment. Such a vehicle speed sensor is available on the commercial market. The vehicle speed sensor 26 transmits a detected vehicle speed to the control section 10.

The control section 10 is a computer equipped with a central processing unit (CPU) 11, a memory section 12, etc. The memory section 12 has a read only memory (ROM), random access memory (RAM), etc. The CPU 11 executes programs such as a program of performing an axial direction control stored in the memory section 12.

FIG. 2 is a flow chart of performing the axial direction adjusting process performed by the control section 10 in the axial direction control device 1 according to the exemplary embodiment.

The control section 10 performs the axial direction adjusting process shown in FIG. 2. This axial direction adjusting process adjusts each of the image acquiring axis of the in-vehicle camera 21 and the optical axis of the headlamps 23 to an optimum direction. In addition, the axial direction adjusting process is started when a power source of the motor vehicle is turned on. The power source such as a battery supplies electric power to the motor vehicle. The axial direction adjusting process is repeatedly executed every period.

In the axial direction adjusting process shown in FIG. 2, the control section 10 acquires a current location information of the motor vehicle on the road transmitted from the position detection section 24 (step S110). The operation flow goes to step S120.

In step S120, the control section 10 retrieves information regarding a change amount of a road gradient at the current location of the motor vehicle transmitted from the data base 25. In step S120, the control section 10 retrieves information regarding a change amount of the road gradient at a change point of the road gradient which is present on the road in front of and near the current location of the motor vehicle. The operation flow goes to step S130.

In step S130, the control section 10 determines a target angle of the image acquiring axis of the in-vehicle camera 21 and a target angle of the optical axis of the headlamp 23 on the basis of the obtained change amount of the road gradient of the change point of the road gradient near the current location of the motor vehicle. Each of the image acquiring axis of the in-vehicle camera 21 and the optical axis of the headlamps 23 has a predetermined angle when the motor vehicle starts to drive. Accordingly, the control section 10 adjusts the angle of the image acquiring axis of the in-vehicle camera 21 and the angle of the optical axis of the headlamp 23 so that each of them has the predetermined angle even if the road gradient is varied. The operation flow goes to step S140.

In step S140, the control section 10 receives information regarding the vehicle speed transmitted from the vehicle speed sensor 26. The operation flow goes to step S150.

In step S150, the control section 10 judges whether or not the change amount of the road gradient of the road is increased or decreased on the basis of the obtained vehicle speed and the change amount of the road gradient.

FIG. 3A is a view explaining the concept regarding a positive (+) direction and a negative (−) direction. In the positive (+) direction, a road gradient is changed upward. In the negative (−) direction, a road gradient is changed downward. That is, as shown in FIG. 3A, when a road surface of the road on which the motor vehicle drives is changed upward (as designated by reference character “+” in FIG. 3A), this case will be referred to as the positive (+) direction. On the other hand, when the road surface of the road is changed downward (as designated by reference character “−” in FIG. 3A), this case will be referred to as the negative (−) direction.

For example, there are following cases when the road gradient is changed to the positive (+) direction, i.e. when the road surface of the road on which the motor vehicle currently drives is changed upward:

The motor vehicle drives on a downward slope and goes forward on a flat road (see the motor vehicle at the right side in FIG. 3B);

The motor vehicle drives on an upward slope and goes forward on another upward slope having a large road gradient; and

The motor vehicle drives on a downward slope and goes forward on an upward slope.

Further, there are following cases when the road gradient is changed to the negative (−) direction, i.e. when the road surface of the road on which the motor vehicle currently drives is changed downward:

The motor vehicle drives on a downward slope and goes forward on another downward slope having a large downward slope;

The motor vehicle drives on an upward slope and goes forward on another upward slope having a small road gradient;

The motor vehicle drives on an upward slope and goes forward on a flat road (see the case at the left side in FIG. 3B); and

The motor vehicle goes forward on a downward slope.

When the judgment result in step S150 indicates affirmation (“YES” in step S150), i.e. indicates that the change amount of the road gradient increases and is changed in the positive (+) direction, the operation flow goes to step S200.

In step S200, the control section 10 determines a completion point B₁ as a target position at which the control section 10 completes the adjustment of the axial direction of the in-vehicle camera 21 and the optical axis of the headlamps 23.

FIG. 3B is a view showing an example of a start point A₂, a start point B₂, a road gradient change position A₀, a road gradient change point B₀, a completion point A₁ and a completion point B₁.

As shown in FIG. 3B, when the change amount of the road gradient is changed in the negative (−) direction, the control section 10 uses the road gradient change position A₀. On the other hand, when the change amount of the road gradient is changed in the positive (+) direction, the control section 10 uses a road gradient change point B₀.

As shown in FIG. 3B, the completion points are designated by reference character A₁ and B₁, respectively, as the target positions at which the change of the axial direction is completed. The start points are designated by reference characters A₂ and B₂, respectively, at which the change of the axial direction is started.

In the exemplary embodiment, the control section 10 uses fixed values as the completion points A₁ and B₁ in views of the road gradient change points A₀ and B₀. The control section 10 adjusts the start points A₂ and B₂ on the basis of the vehicle condition such as the vehicle speed and the road conditions.

In the axial direction control device 1 according to the exemplary embodiment, as shown in FIG. 3B, the control section 10 uses the completion point A₁ which is equal to the road gradient change points A₀ when the road gradient is changed in the negative (−) direction. On the other hand, the control section 10 uses the completion point B₁ which is set before the road gradient change point B₀ (for example, by five meters before of the road gradient change point B₀) when the change direction of the road gradient is in the positive (+) direction.

In step S200, the control section 10 uses the completion point B₁ which is determined in advance. The operation flow goes to step S210.

In step S210, the control section 10 determines an axial speed on the basis of the vehicle speed. Each of the start point B₂, the image acquiring axis of the in-vehicle camera 21 and the optical axis of each of the headlamps 23 is moved on the basis of the determined axial speed.

For example, when using a fixed value of the axial speed, the control section 10 determines the start point B₂ so that the axial adjustment process is completed at the completion point B₁. That is, the more the vehicle speed increases, the more the completion point B₁ is determined before the road gradient change point B₀, i.e. becomes apart from the road gradient change point B₀.

Further, for example, when using a fixed value of the start point B₂, the control section 10 determines the completion point B₁ so that the axial adjustment process is completed. That is, the more the vehicle speed increases, the more the axial speed has a large value. It is also possible for the control section 10 to determine the start point B₂ and the axial speed on the basis of the detected vehicle speed. In this case, the control section 10 determines the completion point B₁ so that the axis adjustment process is completed at the completion point B₁. The operation flow goes to step S220.

In step S220, the control section 10 detects whether or not the current position of the motor vehicle has reached the start point B₂. When the detection result in step S220 indicates negation (“NO” in step S220), i.e. indicates that the motor vehicle has not reached the start point B₂, the operation flow returns to step S110.

On the other hand, when the detection result in step S220 indicates affirmation (“YES” in step S220), i.e. indicates that the motor vehicle has reached the start point B₂, the operation flow returns to step S230.

In step S230, the control section 10 instructs the axial direction adjusting actuator 22 to have the determined axial speed in order to move the image acquiring axis of the in-vehicle camera 21 and the optical axis of the headlamps 23. This makes it possible for the image acquiring axis of the in-vehicle camera 21 and the optical axis of the headlamps 23 to have the target angle. The operation flow goes to step S240.

In step S240, the control section 10 detects whether or not the image acquiring axis of the in-vehicle camera 21 and the optical axis of the headlamps 23 have the target angle.

When the detection result in step S240 indicates negation (“NO” in step S240), i.e. indicates that the image acquiring axis of the in-vehicle camera 21 and the optical axis of the headlamps 23 do not have the target angle, the operation flow returns to step S230.

On the other hand, when the detection result in step S240 indicates affirmation (“YES” in step S240), i.e. indicates that the image acquiring axis of the in-vehicle camera 21 and the optical axis of the headlamps 23 have the target angle, the operation flow returns to step S250.

In step S250, the control section 10 obtains the position information regarding the current location of the motor vehicle transmitted from the position detection section 24. The operation flow goes to step S260.

In step S260, the control section 10 detects whether or not the current location of the motor vehicle has reached the road gradient change point B₀. When the detection result in step S260 indicates negation (“NO” in step S260), the operation flow returns to step S250.

On the other hand, when the detection result in step S260 indicates affirmation (“YES” in step S260), i.e. indicates that the motor vehicle has reached the road gradient change point B₀, the operation flow returns to step S410.

In step S410, the control section 10 instructs the axial direction adjusting actuator 22 to move the image acquiring axis of the in-vehicle camera 21 and the optical axis of the headlamps 23 so that the image acquiring axis of the in-vehicle camera 21 and the optical axis of the headlamps 23 return to a predetermined angle to the road surface. That is, similar to the process in step S230 and step S240, the control section 10 determines the return angle as a target angle, and instructs the axial direction adjusting actuator 22 to move the image acquiring axis of the in-vehicle camera 21 and the optical axis of the headlamps 23 to have the determined target angle.

After the process in step S410, the control section 10 completes the axial direction control process shown in FIG. 2.

When the detection result in step S150 indicates negation (“NO” in step S150), i.e. indicates that the change amount of the road gradient decreases and is changed in the negative (−) direction, the operation flow goes to step S300.

In step S300, the control section 10 determines a completion point A₁. As shown in FIG. 3B, the control section 10 in the axial direction control device 1 according to the exemplary embodiment determines the completion point A₁ which is the same value of the road gradient change point A₀ (see the motor vehicle at the left side in FIG. 3B), as previously described. The operation flow goes to step S310.

In step S310, the control section 10 determines the axial speed on the basis of the vehicle speed. Similar to the process in step S210, each of the start point A₂, the image acquiring axis of the in-vehicle camera 21 and the optical axis of each of the headlamps 23 is moved on the basis of the determined axial speed. The operation flow goes to step S320.

In step S320, the control section 10 detects whether or not the current position of the motor vehicle has reached the start point A₂. When the detection result in step S320 indicates negation (“NO” in step S320), i.e. indicates that the motor vehicle has not reached the start point A₂, the operation flow returns to step S110.

On the other hand, when the detection result in step S320 indicates affirmation (“YES” in step S320), i.e. indicates that the motor vehicle has reached the start point A₂, the operation flow returns to step S330.

In step S330, the control section 10 instructs the axial direction adjusting actuator 22 to have the determined axial speed in order to move the image acquiring axis of the in-vehicle camera 21 and the optical axis of the headlamps 23. This makes it possible for the image acquiring axis of the in-vehicle camera 21 and the optical axis of the headlamps 23 to have the target angle. The operation flow goes to step S340.

In step S340, the control section 10 detects whether or not the image acquiring axis of the in-vehicle camera 21 and the optical axis of the headlamps 23 have the target angle.

When the detection result in step S340 indicates negation (“NO” in step S340), i.e. indicates that the image acquiring axis of the in-vehicle camera 21 and the optical axis of the headlamps 23 do not have the target angle, the operation flow returns to step S330.

On the other hand, when the detection result in step S340 indicates affirmation (“YES” in step S340), i.e. indicates that the image acquiring axis of the in-vehicle camera 21 and the optical axis of the headlamps 23 have the target angle, the operation flow returns to step S350.

In step S350, the control section 10 obtains the position information regarding the current location of the motor vehicle transmitted from the position detection section 24. The operation flow goes to step S360.

In step S360, the control section 10 detects whether or not the current location of the motor vehicle has reached the road gradient change point A₀. When the detection result in step S360 indicates negation (“NO” in step S360), the operation flow returns to step S350.

On the other hand, when the detection result in step S360 indicates affirmation (“YES” in step S360), i.e. indicates that the motor vehicle has reached the road gradient change point A₀, the operation flow returns to step S410.

As previously described, in the process of step S410, the control section 10 instructs the axial direction adjusting actuator 22 to move the image acquiring axis of the in-vehicle camera 21 and the optical axis of the headlamps 23 so that the image acquiring axis of the in-vehicle camera 21 and the optical axis of the headlamps 23 return to the predetermined angle to the road surface.

After the process in step S410, the control section 10 completes the axial direction control process shown in FIG. 2.

### Effects of the Exemplary Embodiment

A description will now be given of the effects of the axial direction control device 1 according to the exemplary embodiment.

As previously described in detail, the control section 10 in the axial direction control device 1 obtains the information regarding the change point (road gradient change point) at which a road gradient is changed and the change amount of the road gradient which is in front of the motor vehicle. The control section 10 adjusts the axial direction of the axial device such as the camera and the headlamps to the road gradient change direction before the motor vehicle has reached the road gradient change positions A₀ and B₀.

According to the axial direction control device 1 of the exemplary embodiment, because the axial direction of the devices (such as the in-vehicle camera 21 and the headlamps 23) mounted on the motor vehicle is changed to the optimum direction after the road gradient is changed, it is possible for the axial of each of the devices to have the optimum axial direction even if the motor vehicle drives on the road and the road gradient thereof varies.

In the axial direction control device 1 according to the exemplary embodiment, the control section 10 determines the completion point B₁ which is located before and apart from the road gradient change point B₀ at which the road gradient is changed in the positive (+) direction (see the motor vehicle at the right side in FIG. 3B) and determine the completion point A₁ which is equal to the road gradient change point A₀ at which the road gradient is changed to the negative (−) direction (see the motor vehicle at the left side in FIG. 3B). In particular, the control section 10 determines the start points A₂ and B₂ so that the distance between the completion point B₁ and the road gradient change point B₀ is longer than the distance between the completion point A₁ and the road gradient change point A₀, where the completion point A₁ and the road gradient change point A₀ are the same point.

According to the axial direction control device 1 having the improved structure and functions previously described, it is possible for the control section 10 to quickly respond to the change of the road gradient and quickly adjust the axial direction of the devices mounted on the motor vehicle to the optimum axial direction. This makes it possible to enhance driver safety and comfort.

Furthermore, according to the axial direction control device 1 having the improved structure and functions previously described, it is possible for the control section 10 to determine the start point B₂ which is located before and apart from the road gradient change point B₀ at which the road gradient is changed in the positive (+) direction (see the motor vehicle at the right side in FIG. 3B) and determine the start point A₂ which is before and apart from the road gradient change point A₀ at which the road gradient is changed in the negative (−) direction (see the motor vehicle at the left side in FIG. 3B). In particular, the control section 10 determines the start points A₂ and B₂ so that the distance between the start point B₂ and the road gradient change point B₀ is longer than the distance between the start point A₂ and the road gradient change point A₀.

According to the axial direction control device 1 having the improved structure and functions previously described, it is possible for the control section 10 to quickly adjust the axial direction of the devices mounted on the motor vehicle to the optimum axial direction corresponding to the change of the road gradient without delay.

Still further, the control section 10 in the axial direction control device 1 according to the exemplary embodiment determines different axial change speeds so that the axial change speed when the road gradient is changed in the negative (−) direction (see the motor vehicle at the left side in FIG. 3B) is larger than the axial change speed when the road gradient is changed in the positive (+) direction (see the motor vehicle at the right side in FIG. 3B).

According to the axial direction control device 1 having the improved structure and functions previously described, it is possible for the control section 10 to quickly adjust the axial direction of the devices mounted on the motor vehicle to the optimum direction when the field of vision is suddenly open.

Further, the control section 10 determines the start point A₂, B₂ so that the more the vehicle speed increases, the more the distance between the start point and the road gradient change point A₀, B₀ is increased, and furthermore increases the axial direction change speed.

According to the axial direction control device 1 having the improved structure and functions previously described, it is possible to quickly adjust the axial direction of the devices mounted on the motor vehicle responding to the change of the road gradient without delay even if the motor vehicle is running at a high speed.

### Other Modifications

The concept of the axial direction control device 1 according to the present invention is not limited by the exemplary embodiment previously described.

For example, the control section 10 instructs the one axial direction adjusting actuator 22 to adjust each of the image acquiring axis of the in-vehicle camera 21 and the optical axis of the headlamps 23 to an optimum direction. However, the concept of the present invention is not limited by this. For example, it is possible for the axial direction control device 1 to have a plurality of axial direction adjusting actuators 22 so that the axial direction adjusting actuators 22 adjust the axial direction of the corresponding devices, respectively.

Further, in the exemplary embodiment previously described, the control section 10 determines the road gradient change point A₀ which is equal to the completion point A₁. However, the concept of the present invention is not limited by this. For example, it is possible for the control section 10 to determine the road gradient change point A₀ which is different from the completion point A₁.

When the control section 10 adjusts the optical axis of the headlamps 23, a delay of adjusting the optical axis of each of the headlamps 23 generates less influence of visibility. On the other hand, a delay of adjusting the image acquiring axis of the in-vehicle camera 21 generates large influence to the execution of the control process on the basis of the acquired image data. Accordingly, it is necessary for the control section 10 to quickly adjust the image acquiring axis of the in-vehicle camera 21.

In the exemplary embodiment previously described, the control section 10 adjusts the image acquiring axis of the in-vehicle camera 21 and the optical axis of the headlamps 23. However, the concept of the present invention is not limited by this. For example, it is possible for the control section 10 to adjust other devices having an input light axis and/or an output light axis.

The control section 10 according to the exemplary embodiment is an example of the axial direction control device. The in-vehicle camera 21 and the headlamps 23 are examples of the devices having an axis. The process in step S120 performed by the control section 10 is an example of the change information acquiring section. The processes in steps S130, S230, S240, S330 and S340 performed by the control section 10 are examples of the change direction section.

The processes in steps S200 and S300 performed by the control section 10 are examples of the completion point determination section. The processes in steps S210 and S310 performed by the control section 10 are examples of the start point determining section and the speed change determination section.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. An axial direction control device capable of controlling an axial direction of devices having an axis into which a light is introduced or from which a light is irradiated, the axial direction control device comprising:
a change information acquiring section capable of acquiring road gradient change information indicating a road gradient change point and a change amount of a road gradient, a gradient of a road, on which a motor vehicle drives, which is changed at the road gradient change point; and
an axial direction change section capable of adjusting an axial direction of the devices to a direction which corresponds to the road gradient of the road after the road gradient change point, before the motor vehicle has reached the road gradient change point on the basis of the road gradient change information.

2. The axial direction control device according to claim 1, wherein the road gradient change point is a first road gradient change point at which the road gradient is changed in a positive direction and a second road gradient change point at which the road gradient is changed in a negative direction, and
the axial direction control device further comprises a completion point determining section capable of determining a first completion point and a second completion point at which a change of the axial direction of the devices is completed by the axial direction change section, so that the first completion point is located before and apart from the first road gradient change point, and the second completion point is equal to or before the second road gradient change point, and a distance between the first completion point and the first road gradient change point is longer than a distance between the second completion point and the second road gradient change point.

3. The axial direction control device according to claim 1, wherein the road gradient change point is a first road gradient change point at which the road gradient is changed to a positive direction and a second road gradient change point at which the road gradient is changed to a negative direction, and
the axial direction control device further comprises a start point determining section capable of determining a first start point and a second start point, at which a change of the axial direction of the devices is started by the axial direction change section, so that the first start point is located before and apart from the first road gradient change point, and the second start point is located before and apart from the second road gradient change point, and a distance between the first start point and the first road gradient change point is longer than a distance between the second start point and the second road gradient change point.

4. The axial direction control device according to claim 1, wherein the road gradient change point is a first road gradient change point at which the road gradient is changed to a positive direction and a second road gradient change point at which the road gradient is changed to a negative direction, and
the axial direction control device further comprises:
a completion point determining section capable of determining a first completion point and a second completion point at which a change of the axial direction of the devices is completed by the axial direction change section, so that the first completion point is located before and apart from the first road gradient change point, and the second completion point is equal to or before the second road gradient change point, and a distance between the first completion point and the first road gradient change point is longer than a distance between the second completion point and the second road gradient change point; and
a start point determining section capable of determining a first start point and a second start point, at which a change of the axial direction of the devices is started by the axial direction change section, so that the first start point is located before and apart from the first road gradient change point, and the second start point is located before and apart from the second road gradient change point, and a distance between the first start point and the first road gradient change point is longer than a distance between the second start point and the second road gradient change point.

5. The axial direction control device according to claim 1, further comprising a speed change determination section capable of determining a change speed comprised of a first change speed and a second change speed with which the axial direction change section changes the axial direction of the devices, wherein the speed change determination section determines the first change speed and the second change speed so that the second change speed used when the road gradient is changed to the negative direction is larger than the first change speed used when the road gradient is changed to the positive direction.

6. The axial direction control device according to claim 3, wherein the start point determining section determines the start point to be further from the road gradient change point with increasing of the vehicle speed of the motor vehicle.

7. The axial direction control device according to claim 5, wherein the speed change determination section increases the change speed with which the axial direction change section adjusts the axial direction of the devices more with increasing the vehicle speed of the motor vehicle.

8. A program stored in a machine-readable storage medium and executable by a central processing unit, capable of processing the function of the axial direction control device according to claim 1.

9. The axial direction control device according to claim 2, further comprising a speed change determination section capable of determining a change speed comprised of a first change speed and a second change speed with which the axial direction change section changes the axial direction of the devices, wherein the speed change determination section determines the first change speed and the second change speed so that the second change speed used when the road gradient is changed to the negative direction is larger than the first change speed used when the road gradient is changed to the positive direction.

10. The axial direction control device according to claim 3, further comprising a speed change determination section capable of determining a change speed comprised of a first change speed and a second change speed with which the axial direction change section changes the axial direction of the devices, wherein the speed change determination section determines the first change speed and the second change speed so that the second change speed used when the road gradient is changed to the negative direction is larger than the first change speed used when the road gradient is changed to the positive direction.

11. The axial direction control device according to claim 4, further comprising a speed change determination section capable of determining a change speed comprised of a first change speed and a second change speed with which the axial direction change section changes the axial direction of the devices, wherein the speed change determination section determines the first change speed and the second change speed so that the second change speed used when the road gradient is changed to the negative direction is larger than the first change speed used when the road gradient is changed to the positive direction.
